(19) United States
(12) Patent Application Publication
(10) Pub. No.: US 2006/0010710 A1
(43) Pub. Date: Jan. 19, 2006

(54) System and method of detecting misaligned wafer

(76) Inventors: Chan-Hoon Park, Seoul (KR); Jong-Haw Lee, Yongin-si (KR); Sang-Sik Kim, Suwon-si (KR); Kwang-Young Park, Osan-si (KR); Kwang-Ho Lee, Suwon-si (KR); Ki-Hyun Chyun, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/150,106

(22) Filed: Jun. 13, 2005

(30) Foreign Application Priority Data
Jul. 13, 2004 (KR) 2004-54386

(51) Int. Cl. F26B 19/00; F26B 7/00

(52) U.S. Cl. 34/423; 34/61

(57) ABSTRACT

A semiconductor manufacturing apparatus includes a wafer guide, and a wafer detecting system to determine whether a wafer is properly seated on a hot plate, by detecting temperature variations for the hot plate when the wafer is positioned onto the hot plate.

### BACKGROUND OF THE INVENTION

1. Technical Field

The present invention generally relates to a semiconductor manufacturing apparatus. More particularly, the present invention relates to a baking apparatus used to bake a photoresist layer during a photolithography process.

A claim of benefit is made to Korean Patent Application No. 2004-54386, filed on Jul. 13, 2004, the disclosure of which is hereby incorporated by reference in its entirety.

2. Discussion of Related Art

In general, semiconductor devices are manufactured through several processes, such as ion implantation, film deposition, diffusion, photolithography, and etching. Among these processes, the photolithography process, which forms a specific pattern on a wafer, is an essential process to manufacture the semiconductor devices.

As size of circuit patterns are further miniaturized due to high integration of the semiconductor devices, various parameters which have an effect on the size of the circuit patterns are severely limited. In particular, the size of a micro pattern is directly affected by the photolithography process.

A pattern on a mask (also known as a reticle) is formed on a wafer through the photolithography process to selectively define a portion on the wafer to be etched, ion implanted, or to be protected from etching or ion implantation. Steps of the photolithography process include a photoresist application, exposure, and development. In the photoresist application step, a photoresist liquid is applied on a surface of a wafer, the wafer is rotated at high speed, and then a photoresist coating is applied to the wafer to a desired thickness. In the exposure step, the wafer is accurately aligned with a mask or reticle, and then the photoresist formed on the wafer is exposed with high intensity ultraviolet light to transfer a pattern onto the surface of the wafer. After the exposure step, the photoresist on the wafer is developed to form a photoresist pattern, which is the development step. In the development step, for a positive photoresist for example, the exposed photoresist is washed away by a developer solution, leaving windows of underlying material. Therefore, the mask contains an exact copy of the pattern on the wafer. In contrast, a negative photoresist remains on the surface where it has been exposed, and the developer solution removes only the unexposed portions.

Other steps include a treatment step with hexamethyl disilane (HMDS), and a bake step to improve adhesion between the photoresist and the wafer. The bake step includes a soft bake and hard bake.

In a soft bake, solvents of the photoresist applied on the wafer are heated at a low temperature to increase the volatility of the solvents. This is done to prevent interference with a chemical reaction of the photoresist in a subsequent exposure step, and to improve interfacial adhesion between an upper surface of the wafer and the photoresist. After the development step, a hard bake is performed to remove solvents and moisture remaining in the photoresist. This improves adhesion between the upper surface of the wafer and the photoresist after the development of the photoresist. The hard bake is generally performed at a temperature that is about 40° C. to about 60° C. relative to a temperature of the soft bake.

A conventional lithography process, including soft and hard bake steps, will now be described with reference to the accompanying drawings.

FIG. 1 illustrates general steps of a conventional photolithography process. Steps performed in a spinner are listed on the left hand side of FIG. 1, while steps performed in a stepper are listed on the right hand side.

First in a spinner, a wafer is treated with hexamethyl disilane to improve the adhesion between a wafer surface and a photoresist, prior to an application of the photoresist. Photoresist in the form of a liquid is applied on the surface of the wafer by a coater. Afterwards, the wafer is subjected to a soft bake on a heating plate, such as a hot plate, at a fixed temperature to remove adhesive liquid from the hexamethyla disilane and solvents from the photoresist liquid, and prepare the applied photoresist for exposure. The soft bake may be divided into several steps.

After the soft bake, the wafer is transferred to a stepper. In the stepper, the wafer is aligned with a defined mask and then exposed to light through the mask. The wafer is returned to the spinner and subjected to a post-exposure bake to adjust the activation state of the exposed photoresist. Then, the wafer is developed to leave an exposed pattern. Afterwards, the wafer is cleaned and is subjected to a hard bake to stabilize the pattern obtained in the development step.

The hard bake step employs a chamber-type baking apparatus in which the wafer is seated on a hot plate within the chamber.

FIG. 2 is a view schematically illustrating a cross section of a hot plate of the conventional baking apparatus.

Referring to FIG. 2, in a baking apparatus 10, a robot (not shown) loads a wafer 18 onto a lift pin 16. Lift pin 16 moves down to seat wafer 18 onto a hot plate 12. A heater (not shown) is installed in or near hot plate 12. A plurality of wafer guides 14 guide wafer 18 onto hot plate 12. However, problems may result from the plurality of wafer guides 14 during the process of loading wafer 18.

FIG. 3 is a view illustrating a wafer misaligned on a hot plate of FIG. 2.

If a position of wafer 18 on hot plate 12 deviates slightly, wafer 18 may be misaligned on wafer guides 14 as shown in FIG. 3. In this case, because wafer 18 is not uniformly heated by hot plate 12, thickness of the photoresist (TPR) may vary, or inconsistency in a critical dimension (CD) may occur in wafer 18. In severe cases, a pattern bridge or no-pattern may occur on wafer 18.

Misalignment of wafer 18 usually results from mechanical error of the robot or positioning error by an operator. If a process is continued under this state, i.e., misalignment of wafer 18, defects may occur in wafer 18, which reduces manufacturing yields. It is difficult in a conventional baking apparatus to accurately detect when wafer 18 is misaligned. In order to increase yields, therefore, a technique to accurately detect whether wafer 18 is precisely seated on hot plate 12, prior to or during a bake process is required.

### SUMMARY OF THE INVENTION

In embodiment of the present invention, a wafer position detecting system includes lift pins to position a wafer on a hot plate, a temperature sensor to measure the temperature of the hot plate, an interlock alarm, and a controller adapted to set a reference temperature value for the hot plate, and to signal the temperature sensor to measure the temperature of the hot plate after the wafer is positioned onto the hot plate by the lift pins, wherein when the measured temperature of the hot plate is less than the reference temperature value, a manufacturing process for the wafer is continued, and when the measured temperature is greater than the reference temperature value, the interlock alarm is activated, and the manufacturing process is stopped.

An embodiment of the present invention includes a method of detecting a misaligned wafer during a photolithography process by inputting a reference temperature value for a hot plate, placing a wafer on lifting pins, lowering the lifting pins to position the wafer onto the hot plate, and measuring a temperature of the hot plate after the wafer is positioned thereon, wherein when the measured temperature is less than the reference temperature value, continuing with the bake process, and when the measured temperature is greater than the reference temperature value, activating an interlock alarm and stopping the bake process.

### BRIEF DESCRIPTION OF THE DRAWINGS

The above and other aspects of the present invention will become more apparent to those of ordinary skill in the art with the description of the preferred embodiments thereof with reference to the attached drawings in which:

FIG. 1 is a view illustrating general steps of a conventional photolithography process;

FIG. 2 is a schematic view illustrating a cross section of a hot plate of a conventional baking apparatus;

FIG. 3 is a view illustrating a misaligned wafer on a hot plate of the baking apparatus in FIG. 2;

FIG. 4 is a graph depicting temperature variations of a hot plate based on an alignment of a wafer;

FIG. 5 is a schematic view of a baking apparatus according to an embodiment of the present invention;

FIG. 6 is a block diagram illustrating a wafer detecting system in FIG. 5;

FIGS. 7A and 7B are timing diagrams depicting timing relations of signals inputted/outputted to/from a wafer detecting system, in the cases where a wafer is properly seated, and when a wafer is caught on wafer guides; and

FIG. 8 is an operating flowchart of the wafer detecting system in FIG. 6.

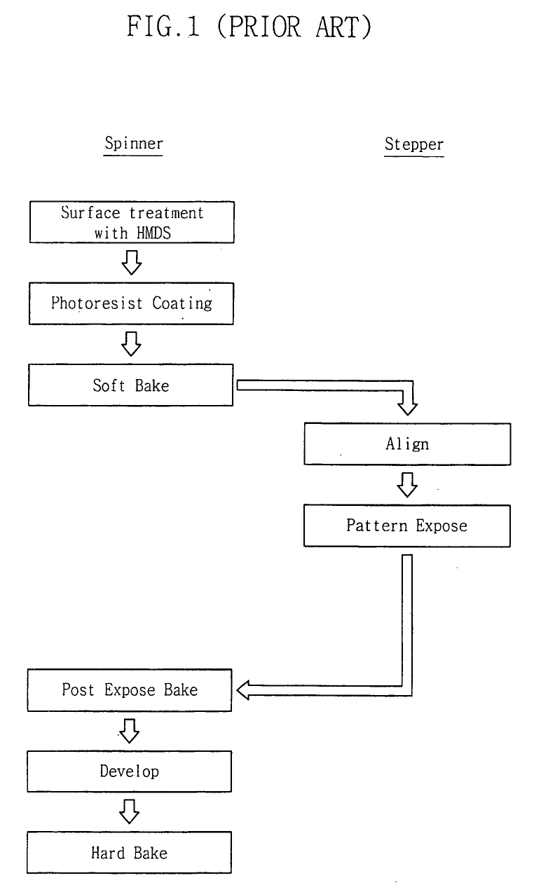

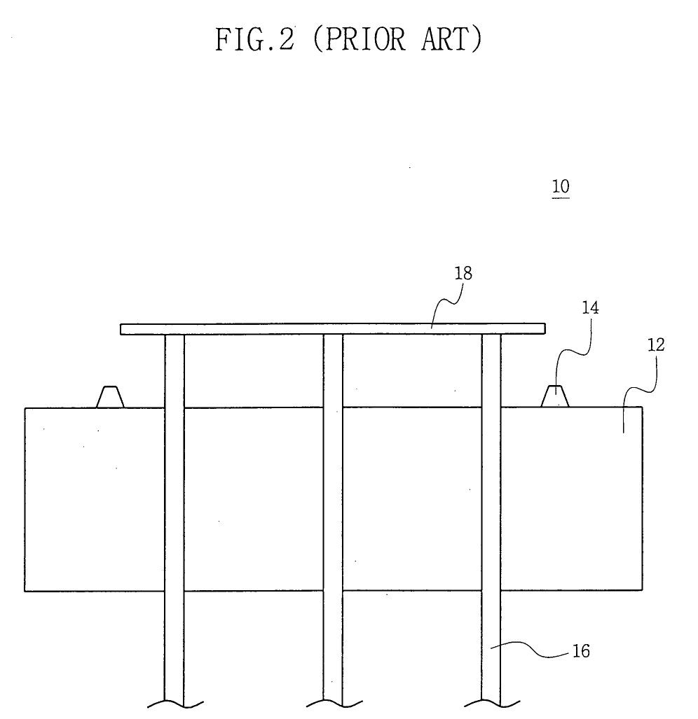

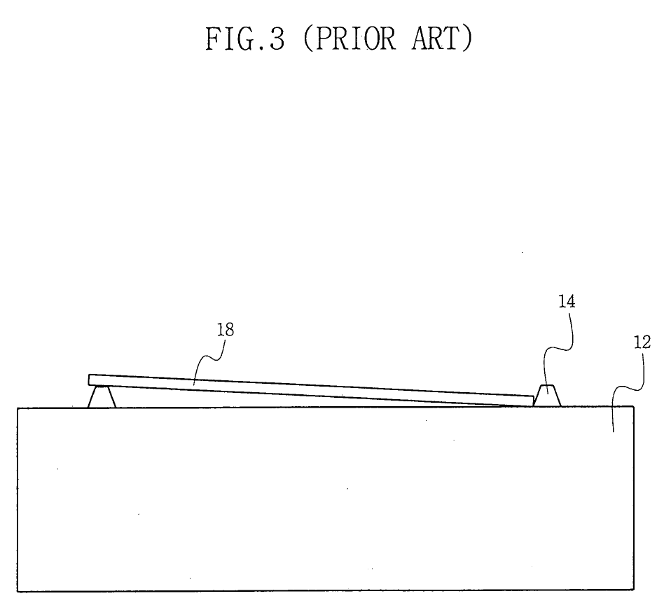

### DETAILED DESCRIPTION OF THE INVENTION

The present invention will now be described more fully hereinafter with reference to the accompanying drawings, in which preferred embodiments of the present invention are shown. The present invention may, however, be embodied in different forms and should not be construed as limited to the embodiments set forth herein. Rather, these embodiments are provided as teaching examples of the present invention. In the drawings and specification, like numbers refer to like elements.

At the outset, it should be noted a hot plate of a wafer baking apparatus is maintained at a fixed temperature. A wafer passes through a cool plate prior to being loaded onto the hot plate. Therefore, the temperature of the hot plate decreases for a short time after a wafer is first placed thereon. In this case, the decrease of the temperature of the hot plate is varies according to the loading state of the wafer. As a result, it is possible to detect an inaccurately loaded wafer by use of the above phenomenon.

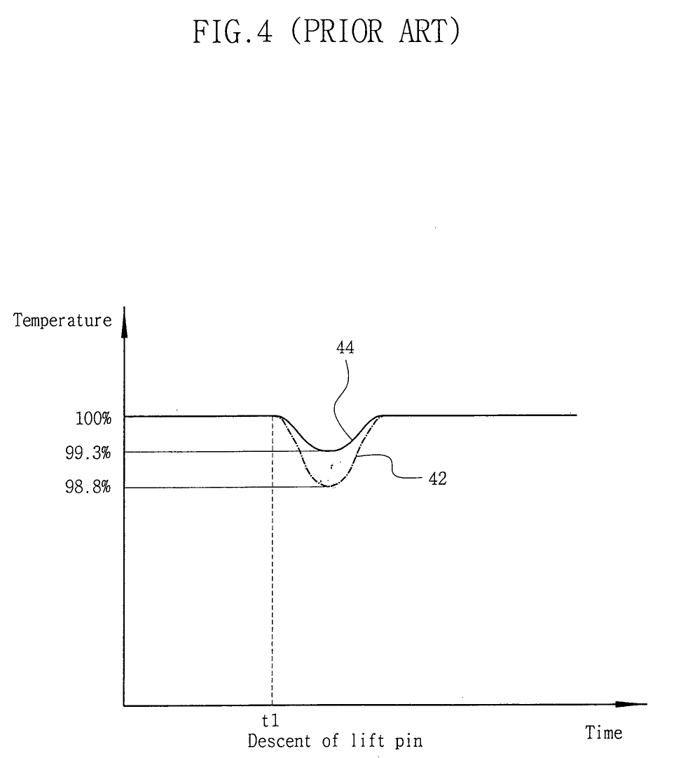

FIG. 4 is a graph depicting temperature variations of a hot plate based on an alignment of a wafer, in which an x-axis indicates time, and a y-axis indicates temperature in percentage.

As depicted in FIG. 4, at a time point where the wafer is directly seated on a hot plate, the temperature of the hot plate decreases for a short period. On the other hand, there is substantially less temperature variation in the case where the wafer is seated on wafer guides of the hot plate. Specifically, in the case where the wafer is directly seated on the hot plate (42 in FIG. 4), the temperature of the hot plate decreases about 1.2% relative to the temperature of the hot plate prior to the wafer seating. On the other hand, in the case where the wafer is placed on the wafer guides (44 in FIG. 4), the temperature of the hot plate decreases about 0.7%, due to a distance between the hot plate and the wafer created by the wafer guides.

Specifically, as shown in FIG. 4, assuming that the temperature of the hot plate is 100° C. prior to loading a wafer on the hot plate, the temperature of the hot plate decreases to about 98.8° C. after a cooled wafer is properly seated on the hot plate (42 in FIG. 4). In contrast, the temperature of the hot plate decreases to about 99.3° C. when a cooled wafer is properly seated on the wafer guides (44 in FIG. 4). A misaligned wafer can be detected based on such a temperature variation.

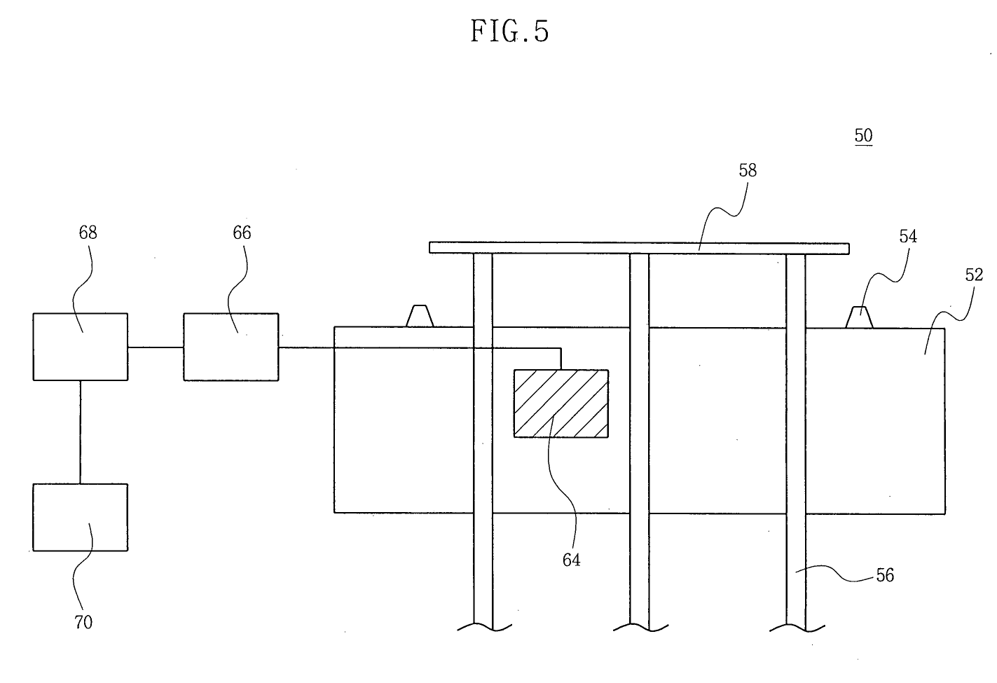

FIG. 5 is a schematic view of a bake apparatus 50 according to an embodiment of the present invention.

Referring to FIG. 5, a wafer 58 is placed on lift pins 56 by a robot (not shown), and then wafer 58 loaded on a hot plate 52 by lowering lift pins 56. Hot plate 52 is provided with a heater (not shown). Wafer 58 on hot plate 52 is subjected to a bake process. The bake is generally performed in about 10 seconds. A plurality of wafer guides 54 are also provided on hot plate 52.

A bake temperature sensor 64 is attached to hot plate 52. Bake temperature sensor 64 may be installed inside of hot plate 52 or at another location. Baking temperature sensor 64 measures the temperature of hot plate 52 during a desired measuring time. The lowest temperature value measured during the measuring time is set as a value of the measured temperature. The value of the measured temperature is transferred to a controller 68 through an interface amplifier 66, which eliminates noise and amplifies signals. Alternatively, controller 68 may include the functions of noise elimination and amplification, in which case interface amplifier 66 may be omitted.

Controller 68 controls bake apparatus 50 on the basis of the measured temperature. A temperature of about 98.8% to 99.3% is set as a reference temperature value (Temp-ref) for hot plate 52. In general, a temperature below about 1% of the normal temperature of hot plate 52 is set as the reference temperature value. The reference temperature value may be set in response to external input by an operator or automatically set by a temperature setting program for controller 68. If the temperature of hot plate 52 measured after wafer 58 has been loaded on hot plate 52, i.e., measured temperature value, is lower than the reference temperature value, controller 68 determines that wafer 58 is properly loaded, and does not activate an alarm interlock 70. If the value of measured temperature is higher than the reference temperature value, controller 68 determines that wafer 58 is misaligned, and activates alarm interlock 70.

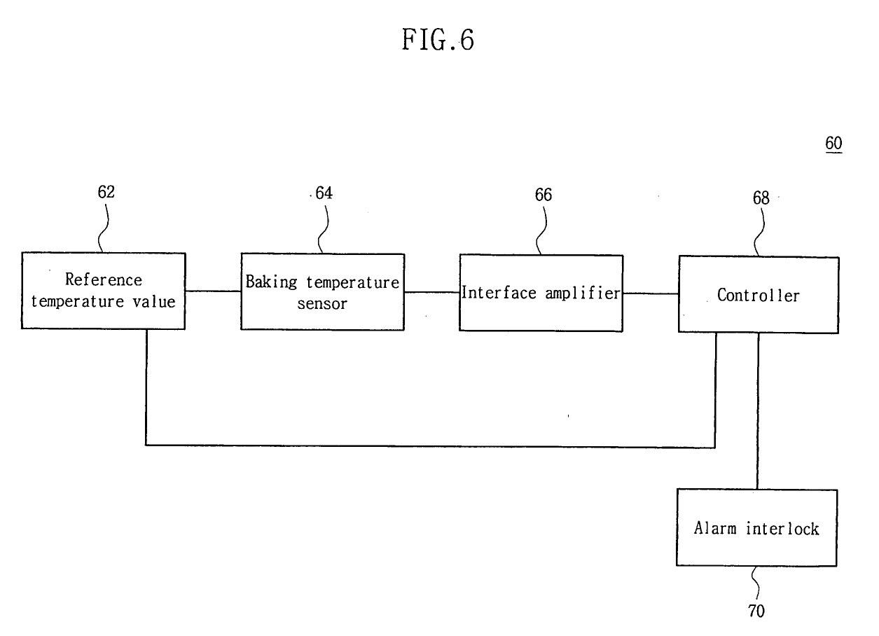

FIG. 6 is a block diagram illustrating a wafer seating detection system 60 that may be employed with the bake apparatus of FIG. 5.

As illustrated in FIG. 6, wafer detecting system 60 includes a reference temperature value 62, baking temperature sensor 64 to detect the temperature of hot plate 50, interface amplifier 66 to transfer the measured temperature value from baking temperature sensor 64 to controller 68 to compare the transferred measured temperature value with of reference temperature valve 62 in order to control wafer detecting system 60, and alarm interlock 70 operated in response to a signal from controller 68.

Alarm interlock 70 stops bake apparatus 50 and activates an audible alarm and/or a visual alarm (e.g., a lamp), in response to the signal from controller 68.

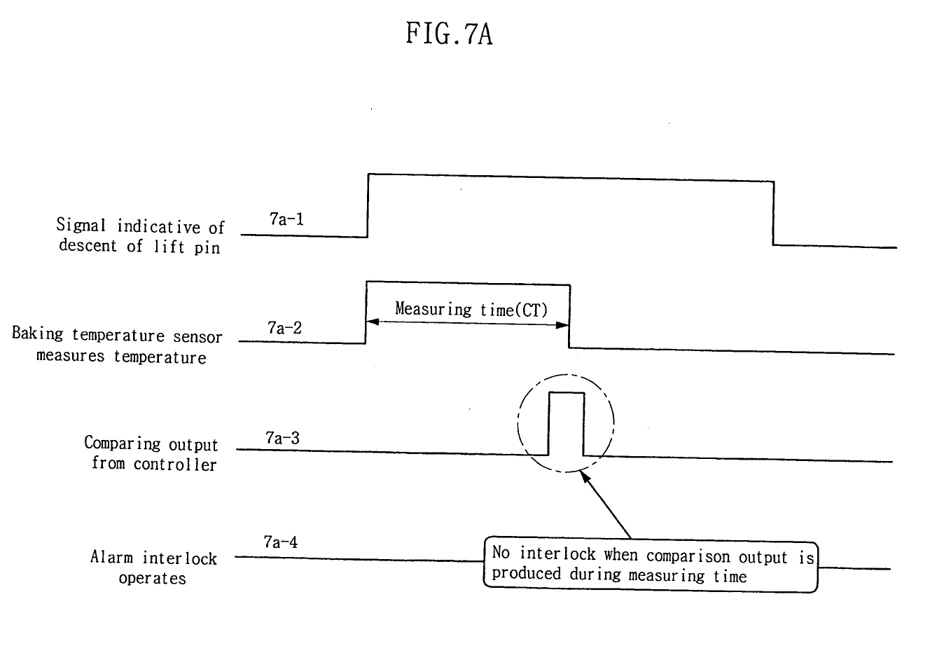

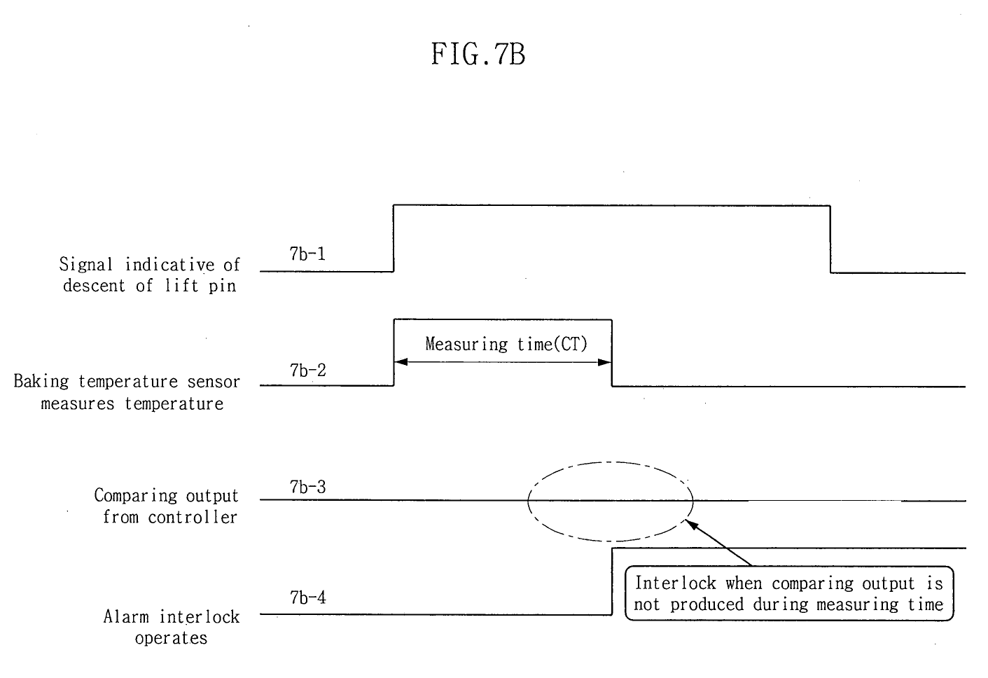

FIGS. 7A and 7B are timing diagrams illustrating timing relations of signals inputted/outputted to/from wafer detecting system 60 in the cases where wafer 58 is properly seated on bake apparatus 50 of FIG. 5, and when wafer 58 is caught on wafer guides 54.

When wafer 58 is properly seated, as shown in FIG. 7A, controller 68 receives a descent signal (7a_1) when lift pin 56 starts to descend. Baking temperature sensor 64 detects the temperature of hot plate 52 during a measuring time interval CT (7a_2). Although the general bake time for wafer 58 in baking chamber is about 10 seconds, the measuring time interval CT is set in a range of about 10 to 70 seconds. This range takes into consideration time required to load/unload wafer 58 on/from hot plate 52. Specifically, the time interval CT is determined based on the time between the baking of one wafer to the baking of a next wafer. The lowest temperature value measured during the measuring time interval CT is set as the measured temperature value. The measured temperature value is transferred to controller 68 through interface amplifier 66. If the temperature of hot plate 52, i.e., the measured temperature value, is lower than the reference temperature value, controller 68 sends a comparision output signal (7a_3), so as not to activate alarm interlock 70 (7a_4).

On the other hand, as shown in FIG. 7B, when wafer 58 is placed on wafer guides 54, controller 68 receives a descent signal (7b_1) indicating the descent of lift pins 56. Baking temperature sensor 64 detects the temperature of hot plate 52 during the measuring time interval CT (7b_2). The measured temperature value is transferred to controller 68 through interface amplifier 66. Since the temperature of hot plate 52, i.e., the measured temperature value, is greater than the reference temperature value, controller 68 does not send the comparison output signal (7b_3), which activates alarm interlock 70 (7b_4). Accordingly, the alarm interlock activates, and the process of bake apparatus 50 is stopped. In addition, an audible alarm or visual alarm is activated, and wafer 58 is regarded as defective, to prevent the wafer from being subject to further manufacturing process. Therefore, the system can prevent possible process defects from occurring in the proceeding process.

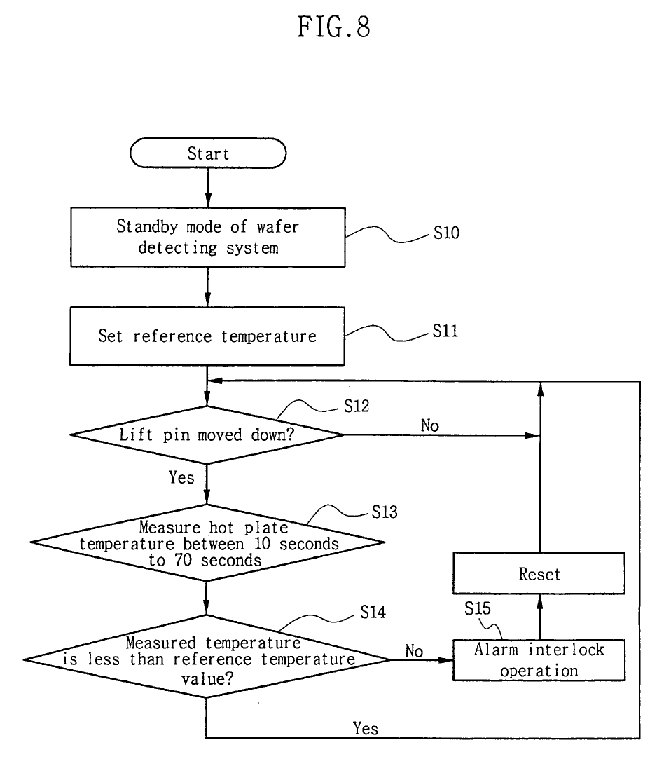

FIG. 8 is an operating flowchart of the wafer detecting system in FIG. 6.

As shown in FIG. 8, a wafer detecting system 50 is in a standby mode, a controller 68 initializes various registers and internal flags (S10). Then, controller 68 sets the value of reference temperature (S11). The value of reference temperature may be set in response to external input by an operator or automatically set by a temperature setting program built into controller 68. When the descent of lift pins 56 is detected (S12), the procedure proceeds to step 13. In step 13, system 50 receives temperature data of a hot plate 52 measured by a bake temperature sensor 64 for a period of about 10 to 70 seconds (measuring time interval) immediately after lift pins 56 have descended. Preferably, the measuring time interval is set to about 70 seconds. The lowest temperature value measured during the measuring time interval is set as the measured temperature value. Controller 68 determines whether the measured temperature value of hot plate 52 is less than the reference temperature value (S14). If the measured temperature value of the hot plate is less than the reference temperature value, an alarm interlock 70 does not activate, and bake apparatus 50 continues to operate normally. On the other hand, if the measured temperature value of hot plate 52 is greater than the reference temperature value, alarm interlock activates 70 (S15). In the case where alarm interlock 70 activates, the operation of the bake apparatus is stopped.

As described above, a wafer detecting system solves some of the problems occurring during a bake process, thereby preventing defects on wafers and reduction of yields.

The present invention has been described with reference to the preferred embodiments. However, it is to be understood that the scope of the present invention is not limited to the disclosed embodiments. On the contrary, the scope of the invention is intended to include various modifications and alternative arrangements within the capabilities of persons skilled in the art. For example, it is apparent that the value of reference temperature of the hot plate may be automatically set or changed according to environmental temperatures, sensing, or controlling methods.

What is claimed is:

1. A wafer position detecting system, comprising:
lift pins to position a wafer on a hot plate;
a temperature sensor to measure the temperature of the hot plate;
an interlock alarm; and
a controller adapted to set a reference temperature value for the hot plate, and to signal the temperature sensor to measure the temperature of the hot plate after the wafer is positioned onto the hot plate by the lift pins, wherein
when the measured temperature of the hot plate is less than the reference temperature value, a manufacturing process for the wafer is continued, and
when the measured temperature is greater than the reference temperature value, the interlock alarm is activated, and the manufacturing process is stopped.

2. The system of claim 1, further comprising:
the guide pins disposed on the hot plate to guide the wafer onto the hot plate; and
an interface amplifier disposed between the temperature sensor and controller.

3. The system of claim 1, wherein the reference temperature value is set between 98.8% to 99.3% of the temperature of the hot plate prior to positioning the wafer onto the hot plate.

4. The system of claim 1, wherein the temperature of the hot plate is measured for about 10 seconds to 70 seconds.

5. The system of claim 1, wherein the wafer is placed on the hot plate by a robot.

6. The system of claim 1, wherein the temperature of the hot plate is measure by a temperature sensor installed on the hot plate.

7. The system of claim 1, wherein the interlock alarm is an audible alarm or a visual alarm.

8. A method of detecting a misaligned wafer during a photolithography process, comprising:
inputting a reference temperature value for a hot plate;
placing a wafer on lifting pins;
lowering the lifting pins to position the wafer onto the hot plate; and
measuring a temperature of the hot plate after the wafer is positioned thereon, wherein
when the measured temperature is less than the reference temperature value, continuing with the bake process, and
when the measured temperature is greater than the reference temperature value, activating an interlock alarm and stopping the bake process.

9. The method of claim 8, wherein the reference temperature value is set between 98.8% to 99.3% of the temperature of the hot plate prior to positioning the wafer on the hot plate.

10. The method of claim 8, wherein the temperature of the hot plate is measured for about 10 seconds to 70 seconds.

11. The method of claim 8, wherein the lowering of the lifting pins and the interlock alarm are controlled by a controller.

12. The method of claim 8, wherein the temperature of the hot plate is measured by a temperature sensor installed in the hot plate.

13. The method of claim 8, wherein the wafer is placed on the lifting pins by a robot.

14. The method of claim 8, wherein the interlock alarm is an audible alarm or a visual alarm.
